(19) United States
(12) Patent Application Publication
(10) Pub. No.: US 2024/0289202 A1
(43) Pub. Date: Aug. 29, 2024

(54) BOOT ERROR REPORTING

(71) Applicant: Intel Corporation, Santa Clara, CA (US)

(72) Inventors: Divya GUPTA, Hillsboro, OR (US); Raed AL-OMARI, Round Rock, TX (US); Yi ZENG, Shanghai (CN); Sheng HUANG, Folsom, CA (US)

(21) Appl. No.: 18/656,375

(22) Filed: May 6, 2024

(30) Foreign Application Priority Data
Dec. 16, 2023 (WO) PCT/CN2023/139320

(51) Int. Cl. G06F 11/07; G06F 9/4401; G06F 13/42

(52) U.S. Cl. CPC G06F 11/0787; G06F 9/4401; G06F 13/4282; G06F 2213/0002

(57) ABSTRACT

Examples described herein relate to a bootable processor that comprises circuitry to load boot firmware. The bootable processor can execute a firmware that is to collect an error log of an error during boot of the bootable processor and that occurred prior to enablement of an Out of Band (OOB) manageability port. The firmware can cause output of the error log to a second circuitry through an interface that is operational prior to enablement of the OOB manageability port.

### RELATED APPLICATION

This application claims the benefit of priority to Patent Cooperation Treaty (PCT) Application No. PCT/CN2023/139320, filed Dec. 16, 2023. The entire contents of that application are incorporated by reference.

### BACKGROUND

If a bootable CPU experiences an error or failure during a boot operation, the bootable CPU can transmit error and failure data via Out of Band (OOB) manageability ports (e.g., Platform Environment Control Interface (PECI) and/or MIPI I3C®) to a server platform for analysis. In a production environment, debug ports (e.g., Joint Test Action Group (JTAG) pins) are disabled by default to mitigate security risks and unable to transmit error or failure data.

### BRIEF DESCRIPTION OF THE DRAWINGS

FIG. 1 depicts an example boot operation of a bootable CPU.

FIG. 2 depicts an example of error indication.

FIG. 3 depicts an example system.

FIG. 4 depicts an example operation.

FIG. 5 depicts example waveforms.

FIG. 6 depicts example waveforms.

FIG. 7 depicts an example operation.

FIG. 8 depicts an example of error-related signaling.

FIGS. 9A-9C depict examples of error reporting.

FIG. 10 depicts an example process.

FIG. 11 depicts an example system.

### DETAILED DESCRIPTION

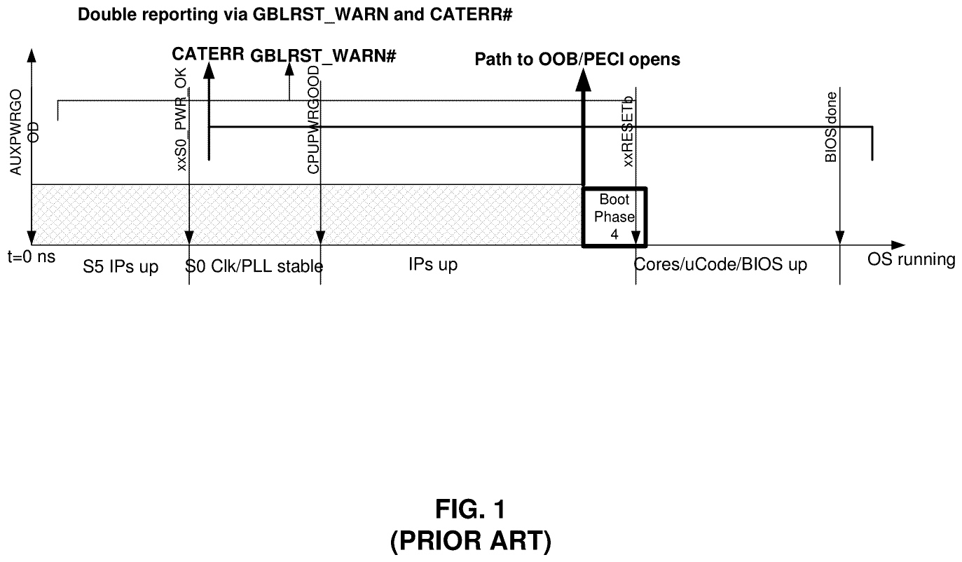

FIG. 1 depicts a prior art example boot operation for a bootable CPU. Before Boot Phase 4, out of band (OOB) manageability ports (e.g., PECI or I3C®) may not be operational to convey crash log information error and failure data (e.g., parity error, uncorrectable errors, or others). Accordingly, a blind spot window can occur before the end of Boot Phase 4, in which error and failure data (e.g., Autonomous Crash Dump (ACD)) may not be accessed. For failures occurring in the blind spot window, and prior to operation of an OOB manageability port, a path or port may not be available to report error details to a server platform, at least in a production environment. However, access to descriptions of errors and failures is pivotal to reduce debug time of the processor and its platform in a production environment.

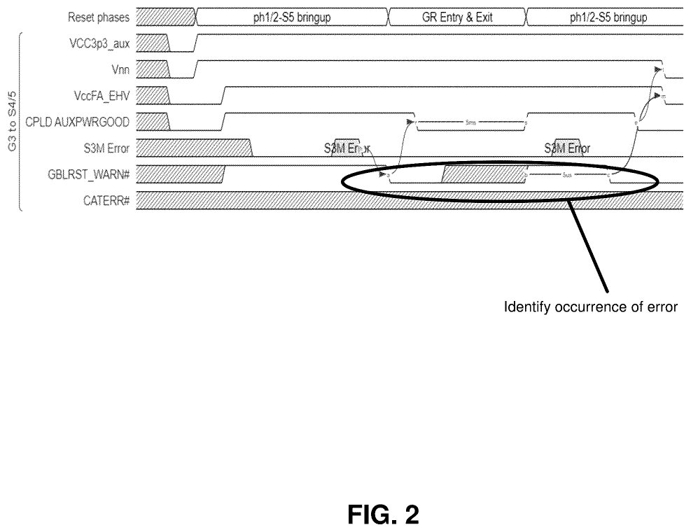

FIG. 2 depicts an example of error indication. In some bootable CPUs, back-to-back assertions of GBLRST_WARN # pin can signal occurrence of a fatal error during boot of the CPU. However, the assertions of GBLRST_WARN # pin can indicate there is an error but not what error occurred or the source of the error. In addition, pre-Boot Phase 4 errors (prior to operation of OOB port) may not be reported.

For in-field platforms, if customers are unequipped to debug production parts, debug engineers are to travel to a customer's site or the customer is to ship parts to a manufacturer for debug. Various examples described herein can potentially accelerate a customer Production Volume Testing (PVT) phase, reduce in-field failure debug system downtime, and allow for reporting of error and failure prior to operation of an OOB port. Various examples can allow retrieval of error logs during early boot window if GBLRST_WARN # has been asserted, even before entering or completing Boot Phase 4. For example, a Security Startup Service module (S3M) firmware (FW) agent can detect and collect error logs; push the error codes to a platform complex programmable logic device (CPLD) over an operational interface (e.g., a Universal Asynchronous Receiver/Transmitter (UART)); and drive GLBRST_WARN # to indicate error during boot. For example, the platform CPLD can receive the error log and store it in a memory space that is accessible by a management controller (e.g., Baseboard Management Controller (BMC)) through an interface (e.g., SMBus).

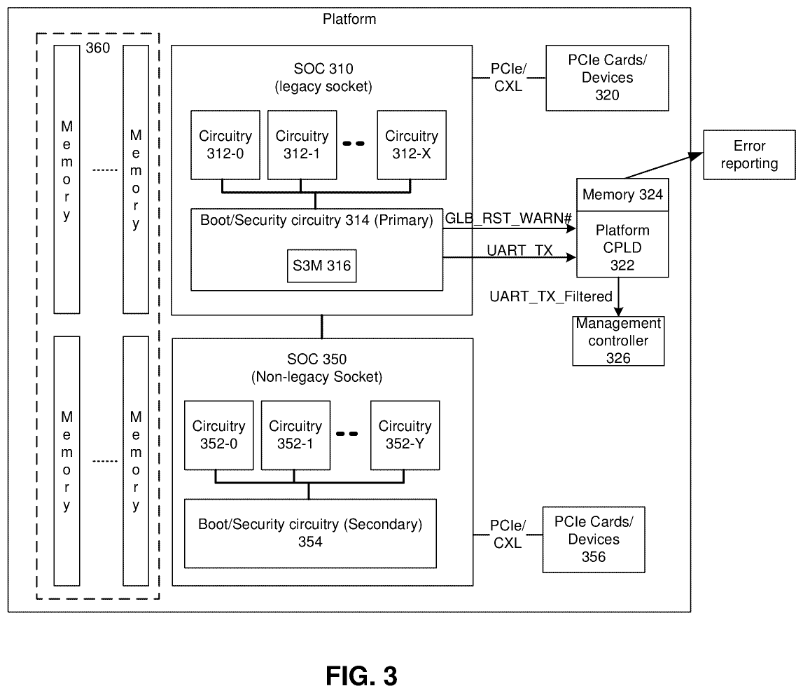

FIG. 3 depicts an example system. In system on chip (SoC) 310, circuitry 312-0 to 312-X, where X is a non-zero integer, can include one or more of: a bootable CPU, processor, graphics processing unit (GPU), neural processing unit (NPU), general purpose GPU, accelerator, uncore mesh, device-to-device interface, input output controller, memory controller, power control unit, or other circuitry. Boot circuitry 314 can execute a firmware or software (e.g., secure start service module (S3M) 316). S3M 316 can be implemented as boot firmware engine in some examples.

As described herein, S3M 316 can perform error detection, error collection, and error reporting to platform CPLD 322 prior to operation of out of band (OOB) interfaces. CPLD 322 can control voltage output to power rails. At least in the event of a fatal error occurring in SOC off or shutdown state (S5) or during loading or execution of boot firmware, S3M 316 can drive GBLRST_WARN # to a logical low state to signal to CPLD 322 that a fatal error occurred. Some examples provide a dedicated memory buffer in CPLD 322 to collect early boot error information from S3M 316 via a UART interface. CPLD 322 can store crash log data in memory 360 and send an error message to management controller 326 (e.g., BMC) over an interface (e.g., UART TX). CPLD 322 can include a field programmable gate array (FPGA) on platform that controls a boot sequence of SoC 310 and/or SoC 350.

S3M FW 316 can report errors from booting one or more of circuitry 312-0 to 312-X at least in Advanced Configuration and Power Interface (ACPI) specification state S5 (e.g., core sleep and pre-wake up)) and pre-boot Phase 4. Error messages can report at least: SPI errors, I2C errors, eSPI errors, SPI flash content error, SPI interface error, SOC failure, S3M internal error, platform interface issue, or others. Based on detecting an error from booting one or more of circuitry 312-0 to 312-X (through assertion of CATERR #), S3M FW 316 can collect internal error log of one or more of circuitry 312-0 to 312-X, signal the platform using GLBRST_WARN # to CPLD 322, and copy the log using Universal Asynchronous Receiver/Transmitter (UART) interface to CPLD 322. S3M FW 316 can transmit an error message to CPLD 322 based on the failure categories (e.g., failure to access SPI flash to retrieve boot firmware, Real Time Clock (RTC) failure, etc.) through UART_TX based on UART protocol. To support timeout for a case where the UART data is corrupted, a byte limit or timeout period can be configured if CPLD 322 does not receive an end of message (EOM) from S3M 316.

In some examples, secondary boot circuitry 354 can report boot errors or errors with one or more of circuitry 352-0 to 352-Y, where Y is an integer, to S3M 316 to report to CPLD 322 in a similar manner as S3M 316 is to report boot errors or errors with one or more of circuitry 312-0 to 312-X.

Management controller 326 can read error data from CPLD 322 over a link, such as SMBus. Based on error messaging, CPLD 322 and/or management controller 326 can perform reliability, availability, and serviceability (RAS) management and perform debug actions to exit a subsequent Global Reset (GR) and not have a persistent error in the system. CPLD 322 and/or management controller 326 can utilize the error information for reset suppression, error data harvest, and RAS management. Based on access to error code information, CPLD 322 and/or management controller 326 can perform autonomous recoverable action based on the error source captured, such as masking the un-expected power button override, releasing the unexpected RTC clear jumper assertion, log the error information into a System Event Log (SEL), apply an error action model based on collected error code. For example, if the error code points to a power button override in prior Global Resets, management controller 326 can mask the power button input. For example, if the error code points to a unreleased RTC clear jumper, management controller 326 can unmask the RTC clear jumper to the RTC silicon.

GR can cause power rails that supply power to an SoC to become de-energized except for the always-on domain (S5). GR can cause a wipe or loss of system state, including error logs. Providing error logs before GR can preserve error logs.

Management controller 326 can perform management and monitoring capabilities for system administrators to monitor operation at least of processor sockets 310 and 350 (and devices connected thereto) using channels, including channels that can communicate data (e.g., in-band channels) and out-of-band channels. Out-of-band channels can include packet flows or transmission media that communicate metadata and telemetry and may not communicate data. Telemetry can include error log data in some examples.

Existing IBL UART TX and GLBRST_WARN # pins can be used to communicate error messages. Due to availability of error data before OOB interfaces are operational, cost savings can result in customer platforms, especially in debug scenarios, e.g., during platform power on, machine check error, multiple reset exit cycles, system hang, CPU catastrophic error debug, or others.

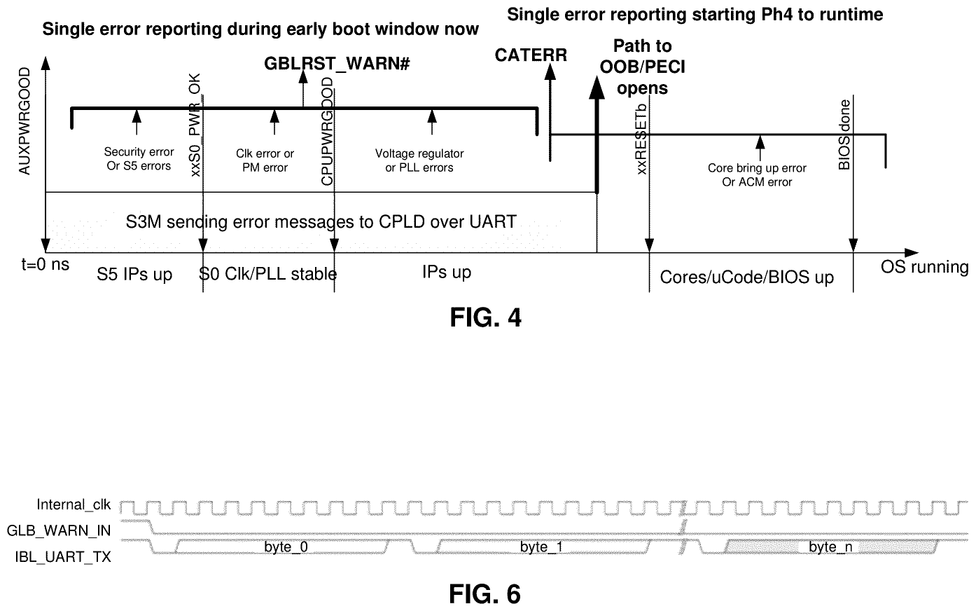

FIG. 4 depicts an example operation. Based on detecting an error from booting one or more of circuitry, S3M FW can collect internal error log of one or more of circuitry, signal the platform using GLBRST_WARN # to CPLD, and copy the log using UART interface to CPLD. Various examples of errors are described earlier. In this example, error messages can be transmitted at the request of a firmware to a CPLD via a UART interface prior to operation of OOB interface (e.g., Boot Phase 4). Accordingly, error messages can be accessible before an OOB interface is available for use.

BIOS done can refer to successful loading of a boot firmware code. In some examples, boot firmware code or firmware can include one or more of: Basic Input/Output System (BIOS), Universal Extensible Firmware Interface (UEFI), or a boot loader. The BIOS firmware can be pre-installed on a personal computer's system board or accessible through an SPI interface from a boot storage (e.g., flash memory). In some examples, a Universal Extensible Firmware Interface (UEFI) can be used instead or in addition to a BIOS for booting or restarting cores or processors. UEFI is a specification that defines a software interface between an operating system and platform firmware. UEFI can read from entries from disk partitions by not just booting from a disk or storage but booting from a specific boot loader in a specific location on a specific disk or storage. UEFI can support remote diagnostics and repair of computers, even with no operating system installed. A boot loader can be written for UEFI and can be instructions that a boot code firmware can execute and the boot loader is to boot the operating system(s). A UEFI bootloader can be a bootloader capable of reading from a UEFI type firmware.

A UEFI capsule is a manner of encapsulating a binary image for firmware code updates. But in some examples, the UEFI capsule is used to update a runtime component of the firmware code. The UEFI capsule can include updatable binary images with relocatable Portable Executable (PE) file format for executable or dynamic linked library (dll) files based on COFF (Common Object File Format). For example, the UEFI capsule can include executable (*.exe) files. This UEFI capsule can be deployed to a target platform as an SMM image via existing OS specific techniques (e.g., Windows Update for Azure, or LVFS for Linux).

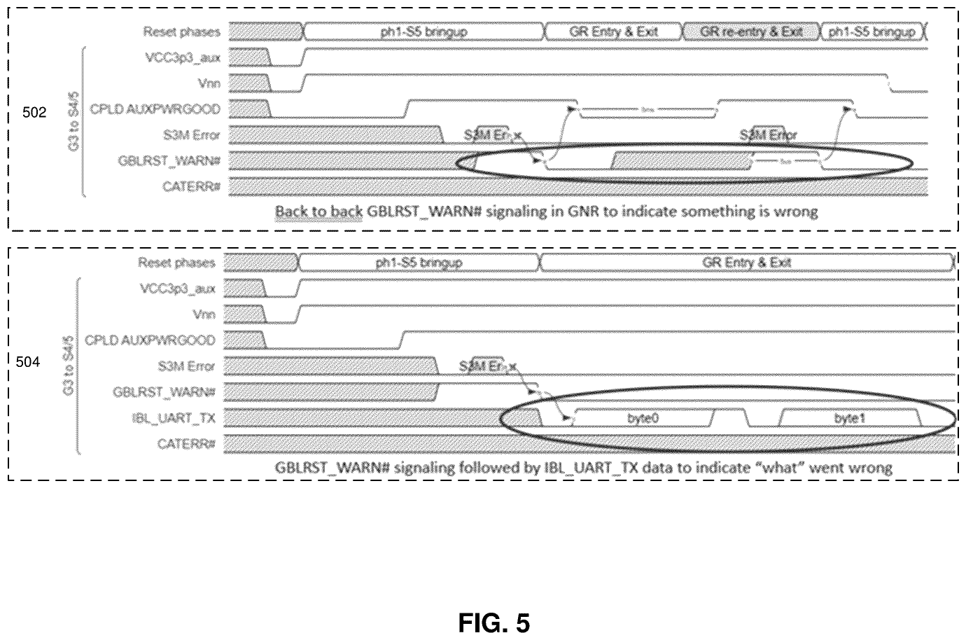

FIG. 5 depicts example waveforms. Waveform 502 depicts back to back GBLRST_WARN # asserted by S3M FW with no information of error output. Waveform 504 depicts S3M FW sending error and failure data on a IBL UART TX interface after asserting GBLRST_WARN #. The CPLD can retrieve the error and failure data before next Global Reset so that error and failure data can be examined to diagnose and correct error and failure issues.

FIG. 6 depicts an example waveform GLBRST_WARN # and IBL_UART_TX. Bytes 0, 1, . . . n can indicate error data such as source of error, time of error, error type, or others. In some examples, n can be a non-zero integer.

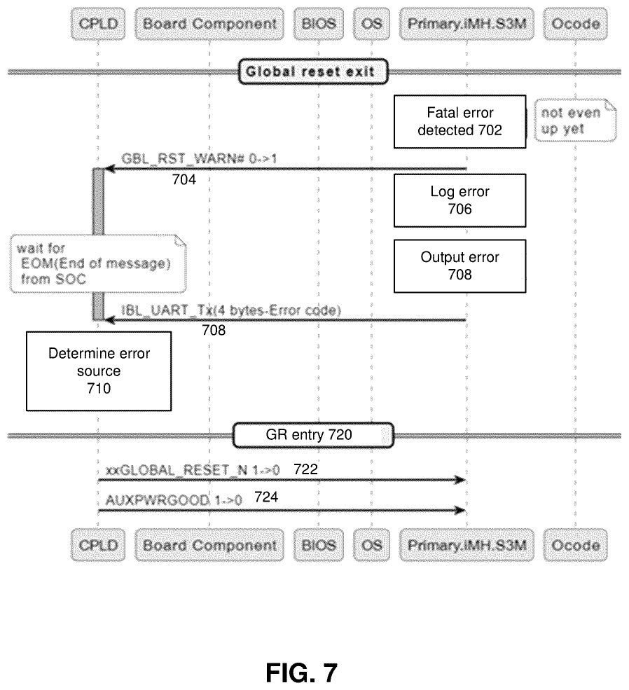

FIG. 7 depicts an example operation. At 702, after exit from GR, a firmware can detect an error during boot of a processor. At 704, the firmware can change GBL_RST_WARN from 0 to 1 state to indicate to CPLD that an error has occurred. At 706, the firmware can log error information. At 708, the firmware can cause transmission of error information and end of message (EOM) indicator to CPLD. The CPLD can distinguish between the error code output mode versus the normal UART mode based on prior assertion of GBL_RST_WARN to 1. After GR entry 720, at 722, CPLD can assert xxGLOBAL_RESET_N from 1 to 0 state to indicate global reset has commenced to S3M firmware. Optionally, at 724, CPLD can change AUXPWRGOOD from 1 to 0 state to indicate to S3M firmware that power rails, which supply power to the bootable processor and other connected devices, are not valid or shut down.

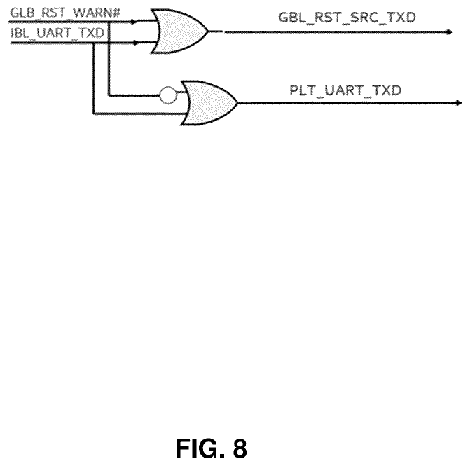

FIG. 8 depicts an example discrete logic or PLD logic to output error-related signal. Examples can provide two UART paths, e.g., UART port (for BIOS post serial log) or debug UART transmit for collecting a number of bytes of early debug data. Signal GLBRST_WARN #GBLRST_WARN # can indicate a request to perform an early reset of the SoC due to error during boot. Signal IBL_UART_TXD can indicate an error message is transmitted. A NOR operation can occur with inputs GLBRST_WARN # and IBL_UART_TXD. Signal GLBRST_WARN # and signal IBL_UART_TXD (output from the S3M UART transmit (Tx) pin) can be provided to logical OR gates. Masking logic (OR gates) can enable functional UART path when GLBRST_WARN #=1 (de-asserted) and enable debug UART transmit path when GLBRST_WARN #=0 (asserted).

Signal GBL_RST_SRC_TXD can transfer dedicated UART TX signals from signal IBL_UART_TXD and can be output to CPLD circuitry so that CPLD circuitry can decode the error code information from a processor. Signal PLT_UART_TXD can transfer a UART output from signal IBL_UART_TXD for BIOS log and OS console usage to CPLD circuitry.

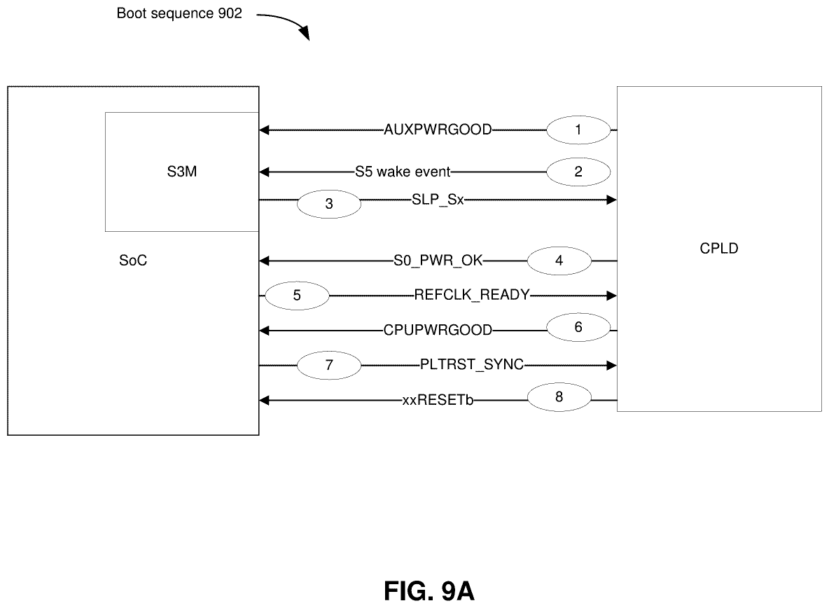

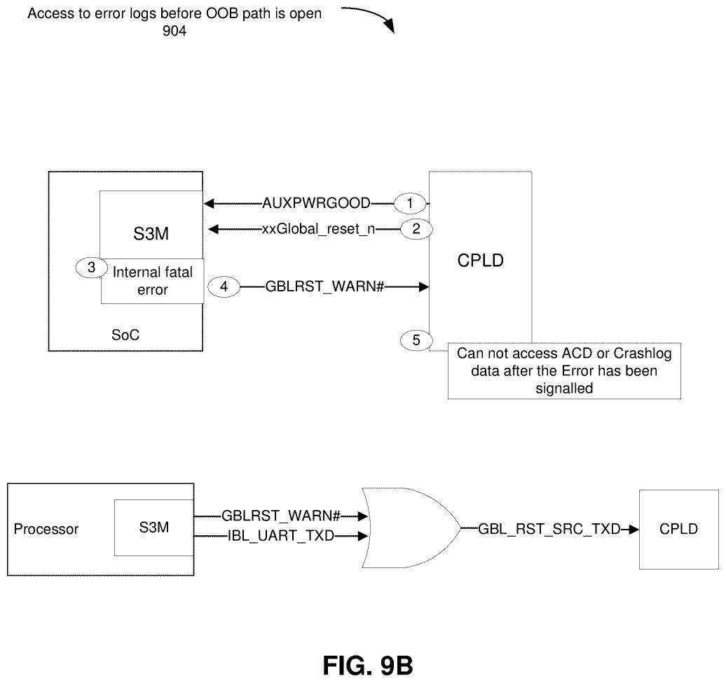

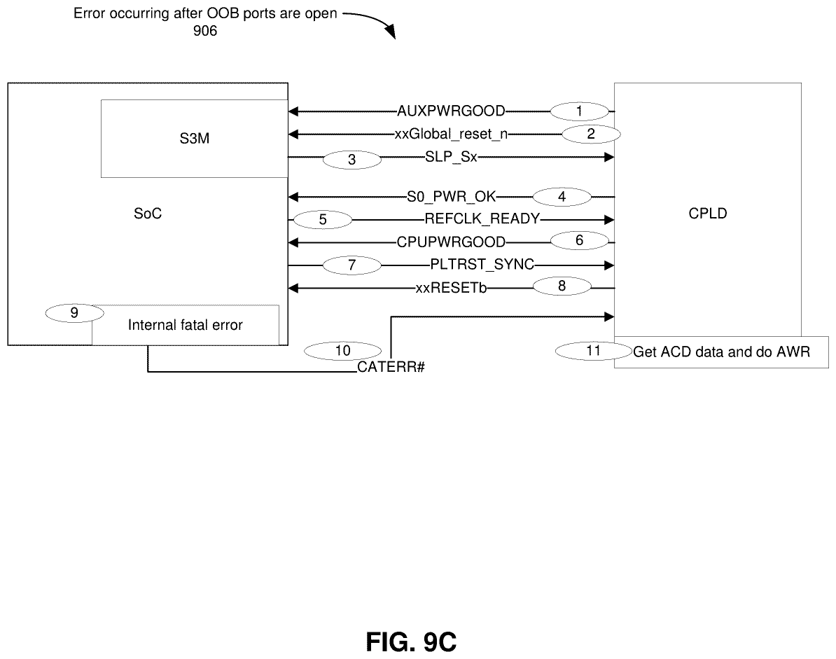

FIGS. 9A-9C depict examples of error reporting. Boot sequence 902 can represent an interaction between an SoC and CPLD for a successful boot sequence with no errors or failure. At (1), AUXPWRGOOD can indicate power rail supplying (S5) is supplying a stable power level to the SoC. At (2), S5 wake event can indicate to the S3M and SoC to wake up (S0). At (3), SLP_Sx can indicate to CPLD that the SoC has woken up (exited from S5). At (4), S0_PWR_OK indicates that the power voltage is stable. At (5), REFCLK_READY can indicate that a reference clock signal is available to the SoC. At (6), CPUPWRGOOD can indicate a power rail for the CPU provides a stable voltage. At (7), PLTRST_SYNC can indicate a boot operation has completed and to deassert a reset state. At (8), xxRESETb can indicate reset state deactivated.

Boot sequence 904 can represent an example in which error logs can be transmitted from SoC to CPLD using a UART interface before OOB interface(s) are active. For example, an error occurring before Phase 4 can cause GBLRST_WARN # assertion indicating error before S5 exit. At (1), AUXPWRGOOD can indicate power rail supplying is supplying a stable power level. At (2), xxGlobal_reset_n can command the SoC to exit reset. At (3), an internal error is detected during boot (e.g., failure to execute boot firmware or error with boot firmware). At (4), GBLRST_WARN # can indicate a request to perform an early reset of the SoC due to error during boot. At (5), CPLD cannot access ACD or crashlog data after the error (GBLRST_WARN #) has been signaled.

Boot sequence 906 can represent an example of a boot error occurring after OOB interface(s) are active. SoC can assert a CATERR signal to CPLD. SoC can indicate a cause of boot error can be debugged by a management controller via an OOB interface, triggering warm reset asynchronously to the platform for recovery. CPLD can forward Autonomous Crash Dump (ACD) data and Asynchronous Warm Reset (AWR) data to the management controller. An AWR can cause reduction of power from voltage rails and performing a power cycle, which could cause system state to be lost.

Operations (1)-(8) are described with respect to boot sequence 902. At (9), an internal error is detected during boot (e.g., failure to execute boot firmware or error with boot firmware). At (10), CATERR # can indicate using an OOB port that an error occurred. At (11), the CPLD can access the ACD data and perform an Asynchronous Warm Reset (AWR) on SoC to cause.

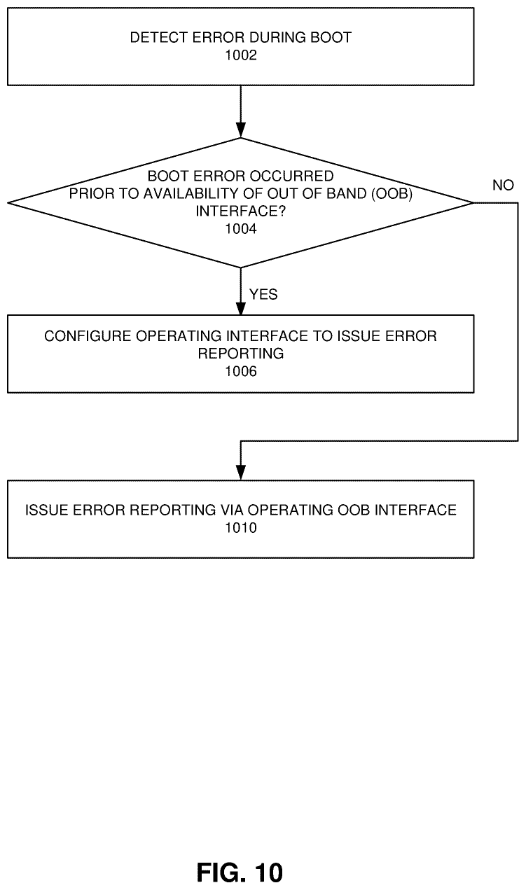

FIG. 10 depicts an example process. The process can be performed by a firmware and/or other circuitry of a bootable processor or an SoC with a bootable processor. At 1002, an error can be detected during boot of a bootable processor. Booting of a bootable processor can include loading boot firmware, changing a power state of a processor, or other operations. At 1004, based on detection of an error during boot, a determination can be made as to whether the error was detected before an OOB interface is operational. Based on the error being detected at or after the OOB interface is operational, the process can proceed to 1006. At 1006, an operating interface (e.g., UART) to a power management circuitry (e.g., CPLD) can be configured to transfer error log information indicative of the error detected during boot.

At 1004, based on the error being detected before the OOB interface is operational, the process can proceed to 1010. At 1010, the error log information indicative of the error detected during boot can be transmitted using an OOB interface (e.g., PECI or I3C).

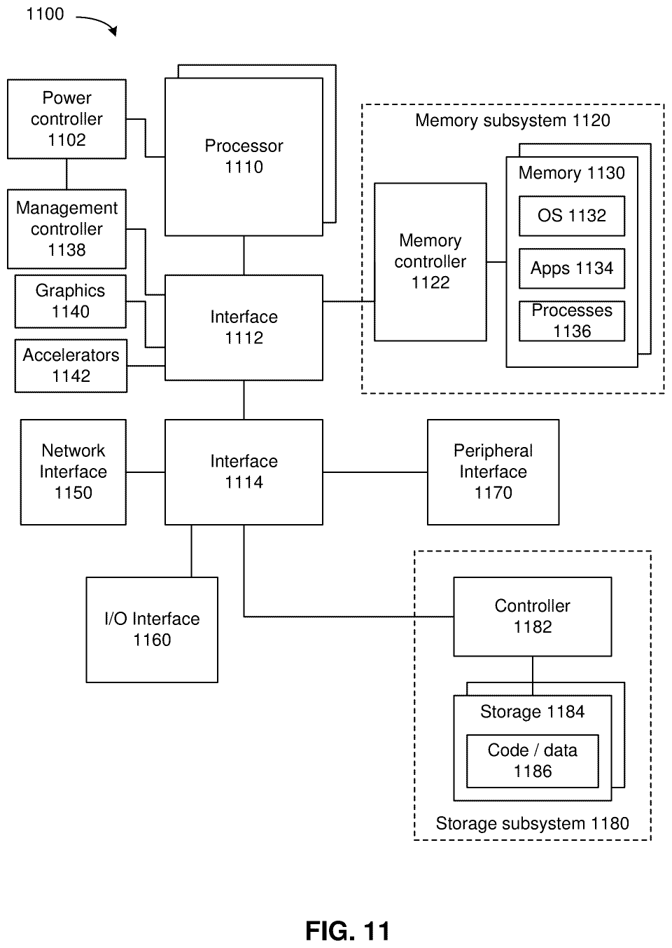

FIG. 11 depicts a system. In some examples, circuitry of system 1100 can detect and report errors, as described herein. System 1100 includes processor 1110, which provides processing, operation management, and execution of instructions for system 1100. Processor 1110 can include any type of microprocessor, central processing unit (CPU), graphics processing unit (GPU), XPU, processing core, or other processing hardware to provide processing for system 1100, or a combination of processors. An XPU can include one or more of: a CPU, a graphics processing unit (GPU), general purpose GPU (GPGPU), and/or other processing units (e.g., accelerators or programmable or fixed function FPGAs). Processor 1110 controls the overall operation of system 1100, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1100 includes interface 1112 coupled to processor 1110, which can represent a higher speed interface or a high throughput interface for system components that needs higher bandwidth connections, such as memory subsystem 1120 or graphics interface components 1140, or accelerators 1142. Interface 1112 represents an interface circuit, which can be a standalone component or integrated onto a processor die.

As described herein, processor 1110 can include a bootable processor that issues error reports to power controller 1102 before an OOB interface is available and power controller 1102 can provide the error reports to management controller 1138 for analysis and action.

Where present, graphics interface 1140 interfaces to graphics components for providing a visual display to a user of system 1100. In one example, graphics interface 1140 generates a display based on data stored in memory 1130 or based on operations executed by processor 1110 or both. In one example, graphics interface 1140 generates a display based on data stored in memory 1130 or based on operations executed by processor 1110 or both.

Accelerators 1142 can be a programmable or fixed function offload engine that can be accessed or used by a processor 1110. For example, an accelerator among accelerators 1142 can provide data compression (DC) capability, cryptography services such as public key encryption (PKE), cipher, hash/authentication capabilities, decryption, or other capabilities or services. In some cases, accelerators 1142 can be integrated into a processor socket (e.g., a connector to a motherboard or circuit board that includes a CPU and provides an electrical interface with the CPU). For example, accelerators 1142 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1142 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 1120 represents the main memory of system 1100 and provides storage for code to be executed by processor 1110, or data values to be used in executing a routine. Memory subsystem 1120 can include one or more memory devices 1130 such as read-only memory (ROM), flash memory, one or more varieties of random access memory (RAM) such as DRAM, or other memory devices, or a combination of such devices. Memory 1130 stores and hosts, among other things, operating system (OS) 1132 to provide a software platform for execution of instructions in system 1100. Additionally, applications 1134 can execute on the software platform of OS 1132 from memory 1130. Applications 1134 represent programs that have their own operational logic to perform execution of one or more functions. Processes 1136 represent agents or routines that provide auxiliary functions to OS 1132 or one or more applications 1134 or a combination. OS 1132, applications 1134, and processes 1136 provide software logic to provide functions for system 1100. In one example, memory subsystem 1120 includes memory controller 1122, which is a memory controller to generate and issue commands to memory 1130. It will be understood that memory controller 1122 could be a physical part of processor 1110 or a physical part of interface 1112. For example, memory controller 1122 can be an integrated memory controller, integrated onto a circuit with processor 1110.

Applications 1134 and/or processes 1136 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 1132 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, or compatible with reduced instruction set computer (RISC) instruction set architecture (ISA) (e.g., RISC-V), among others.

While not specifically illustrated, it will be understood that system 1100 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1100 includes interface 1114, which can be coupled to interface 1112. In one example, interface 1114 represents an interface circuit, which can include standalone components and integrated circuitry. In one example, multiple user interface components or peripheral components, or both, couple to interface 1114. Network interface 1150 provides system 1100 the ability to communicate with remote devices (e.g., servers or other computing devices) over one or more networks. Network interface 1150 can include an Ethernet adapter, wireless interconnection components, cellular network interconnection components, USB (universal serial bus), or other wired or wireless standards-based or proprietary interfaces. Network interface 1150 can transmit data to a device that is in the same data center or rack or a remote device, which can include sending data stored in memory. Network interface 1150 can receive data from a remote device, which can include storing received data into memory. In some examples, packet processing device or network interface device 1150 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 1100 includes one or more input/output (I/O) interface(s) 1160. I/O interface 1160 can include one or more interface components through which a user interacts with system 1100. Peripheral interface 1170 can include any hardware interface not specifically mentioned above. Peripherals refer generally to devices that connect dependently to system 1100.

In one example, system 1100 includes storage subsystem 1180 to store data in a nonvolatile manner. In one example, in certain system implementations, at least certain components of storage 1180 can overlap with components of memory subsystem 1120. Storage subsystem 1180 includes storage device(s) 1184, which can be or include any conventional medium for storing large amounts of data in a nonvolatile manner, such as one or more magnetic, solid state, or optical based disks, or a combination. Storage 1184 holds code or instructions and data 1186 in a persistent state (e.g., the value is retained despite interruption of power to system 1100). Storage 1184 can be generically considered to be a “memory,” although memory 1130 is typically the executing or operating memory to provide instructions to processor 1110. Whereas storage 1184 is nonvolatile, memory 1130 can include volatile memory (e.g., the value or state of the data is indeterminate if power is interrupted to system 1100). In one example, storage subsystem 1180 includes controller 1182 to interface with storage 1184. In one example controller 1182 is a physical part of interface 1114 or processor 1110 or can include circuits or logic in both processor 1110 and interface 1114.

A volatile memory can include memory having a state (and therefore the data stored in it) is indeterminate if power is interrupted to the device. A non-volatile memory (NVM) device can include a memory whose state is determinate even if power is interrupted to the device.

In some examples, system 1100 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 1100 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes one or more examples, and includes an apparatus that includes: a bootable processor that comprises circuitry to load boot firmware, wherein: the bootable processor is to execute a firmware that is to collect an error log of an error during boot of the bootable processor and that occurred prior to enablement of an Out of Band (OOB) manageability port and the firmware is to cause output of the error log to a second circuitry through an interface that is operational prior to enablement of the OOB manageability port.

Example 2 includes one or more examples, wherein the interface that is operational prior to enablement of the OOB manageability port is to operate in a manner consistent with Universal Asynchronous Receiver/Transmitter (UART).

Example 3 includes one or more examples, wherein the error log is to identify one or more of: Serial Peripheral Interface (SPI) error, I2C error, Enhanced Serial Peripheral Interface (eSPI) error, or SPI flash content error.

Example 4 includes one or more examples, wherein the second circuitry comprises a power controller circuitry.

Example 5 includes one or more examples, wherein a debug of a system comprising the bootable processor is based on the error log.

Example 6 includes one or more examples, wherein the OOB manageability port is consistent with Platform Environment Control Interface (PECI) and/or MIPI I3C®.

Example 7 includes one or more examples, wherein based on occurrence of the error during operation of the OOB manageability port, the firmware is to cause output of information associated with the error from the OOB manageability port.

Example 8 includes one or more examples, wherein based on the error, the bootable processor is to perform one or more of: reset suppression, error data harvest, and/or reliability, availability, and serviceability (RAS) management.

Example 9 includes one or more examples, and includes at least one non-transitory computer-readable medium, comprising instructions stored thereon, that when executed by a bootable processor that comprises circuitry to load boot firmware, causes the bootable processor to: execute a firmware that is to collect an error log of an error during boot of the bootable processor and that occurred prior to enablement of an Out of Band (OOB) manageability port and the firmware is to cause output of the error log to a second circuitry through an interface that is operational prior to enablement of the OOB manageability port.

Example 10 includes one or more examples, wherein the interface that is operational prior to enablement of the OOB manageability port is to operate in a manner consistent with Universal Asynchronous Receiver/Transmitter (UART).

Example 11 includes one or more examples, wherein the error log is to identify one or more of: Serial Peripheral Interface (SPI) error, I2C error, Enhanced Serial Peripheral Interface (eSPI) error, or SPI flash content error.

Example 12 includes one or more examples, wherein the second circuitry comprises a power management circuitry.

Example 13 includes one or more examples, wherein the OOB manageability port is consistent with Platform Environment Control Interface (PECI) and/or MIPI I3C®.

Example 14 includes one or more examples, and includes instructions stored thereon, that when executed by the bootable processor, causes the bootable processor to: for the error occurring during operation of the OOB manageability port, output of information associated with the error from the OOB manageability port.

Example 15 includes one or more examples, and includes a method comprising: a bootable processor that comprises circuitry to load boot firmware performing: collecting an error log of an error during boot of the bootable processor and that occurred prior to enablement of an Out of Band (OOB) manageability port and outputting of the error log to a second circuitry through an interface that is operational prior to enablement of the OOB manageability port.

Example 16 includes one or more examples, wherein the interface that is operational prior to enablement of the OOB manageability port is to operate in a manner consistent with Universal Asynchronous Receiver/Transmitter (UART).

Example 17 includes one or more examples, wherein the error log is to identify one or more of: Serial Peripheral Interface (SPI) error, I2C error, Enhanced Serial Peripheral Interface (eSPI) error, or SPI flash content error.

Example 18 includes one or more examples, and includes based on the error log, debugging a system comprising the bootable processor.

Example 19 includes one or more examples, and includes for the error that occurs during operation of the manageability port, outputting of information associated with the caror from the OOB manageability port.

Example 20 includes one or more examples, and includes based on the error, performing one or more of: reset suppression, error data harvest, and/or reliability, availability, and serviceability (RAS) management.

1. An apparatus comprising:
a bootable processor that comprises circuitry to load boot firmware, wherein:
the bootable processor is to execute a firmware that is to collect an error log of an error during boot of the bootable processor and that occurred prior to enablement of an Out of Band (OOB) manageability port and
the firmware is to cause output of the error log to a second circuitry through an interface that is operational prior to enablement of the OOB manageability port.

2. The apparatus of claim 1, wherein the interface that is operational prior to enablement of the OOB manageability port is to operate in a manner consistent with Universal Asynchronous Receiver/Transmitter (UART).

3. The apparatus of claim 1, wherein the error log is to identify one or more of: Serial Peripheral Interface (SPI) error, I2C error, Enhanced Serial Peripheral Interface (eSPI) error, or SPI flash content error.

4. The apparatus of claim 1, wherein the second circuitry comprises a power controller circuitry.

5. The apparatus of claim 1, wherein a debug of a system comprising the bootable processor is based on the error log.

6. The apparatus of claim 1, wherein the OOB manageability port is consistent with Platform Environment Control Interface (PECI) and/or MIPI I3C®.

7. The apparatus of claim 1, wherein
based on occurrence of the error during operation of the OOB manageability port, the firmware is to cause output of information associated with the error from the OOB manageability port.

8. The apparatus of claim 1, wherein
based on the error, the bootable processor is to perform one or more of: reset suppression, error data harvest, and/or reliability, availability, and serviceability (RAS) management.

9. At least one non-transitory computer-readable medium, comprising instructions stored thereon, that when executed by a bootable processor that comprises circuitry to load boot firmware, causes the bootable processor to:
execute a firmware that is to collect an error log of an error during boot of the bootable processor and that occurred prior to enablement of an Out of Band (OOB) manageability port and
the firmware is to cause output of the error log to a second circuitry through an interface that is operational prior to enablement of the OOB manageability port.

10. The non-transitory computer-readable medium of claim 9, wherein the interface that is operational prior to enablement of the OOB manageability port is to operate in a manner consistent with Universal Asynchronous Receiver/Transmitter (UART).

11. The non-transitory computer-readable medium of claim 9, wherein the error log is to identify one or more of: Serial Peripheral Interface (SPI) error, I2C error, Enhanced Serial Peripheral Interface (eSPI) error, or SPI flash content error.

12. The non-transitory computer-readable medium of claim 9, wherein the second circuitry comprises a power management circuitry.

13. The non-transitory computer-readable medium of claim 9, wherein the OOB manageability port is consistent with Platform Environment Control Interface (PECI) and/or MIPI I3C®.

14. The non-transitory computer-readable medium of claim 9, comprising instructions stored thereon, that when executed by the bootable processor, causes the bootable processor to:
for the error occurring during operation of the OOB manageability port, output of information associated with the error from the OOB manageability port.

15. A method comprising:
a bootable processor that comprises circuitry to load boot firmware performing:
collecting an error log of an error during boot of the bootable processor and that occurred prior to enablement of an Out of Band (OOB) manageability port and
outputting of the error log to a second circuitry through an interface that is operational prior to enablement of the OOB manageability port.

16. The method of claim 15, wherein the interface that is operational prior to enablement of the OOB manageability port is to operate in a manner consistent with Universal Asynchronous Receiver/Transmitter (UART).

17. The method of claim 15, wherein the error log is to identify one or more of: Serial Peripheral Interface (SPI) error, I2C error, Enhanced Serial Peripheral Interface (eSPI) error, or SPI flash content error.

18. The method of claim 15, comprising:
based on the error log, debugging a system comprising the bootable processor.

19. The method of claim 15, comprising:
for the error that occurs during operation of the manageability port, outputting of information associated with the error from the OOB manageability port.

20. The method of claim 15, comprising:
based on the error, performing one or more of: reset suppression, error data harvest, and/or reliability, availability, and serviceability (RAS) management.
